(19) United States
(12) Patent Application Publication
(10) Pub. No.: US 2008/0031782 A1
(43) Pub. Date: Feb. 7, 2008

(54) Microfluidic device with valve and method

(76) Inventors: Timothy Beerling, San Francisco, CA (US); Reid A. Brennen, San Francisco, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/500,234

(22) Filed: Aug. 7, 2006

(51) Int. Cl. B01L 11/00; B01L 3/00

(52) U.S. Cl. 422/103; 422/99

(57) ABSTRACT

The invention provides a microfluidic system, including an optional separation system for separating and preparing an analyte solution, a microfluidic device downstream from the separation system for dispensing and analyte solution, comprising a substrate having a channel defining a portion of a microfluidic channel; a polymeric substrate having a channel for contacting the substrate to define the second portion of the microfluidic channel; a cooling element associated with the substrate and channel for cooling an analyte solution in the microfluidic channel; and a heating element adjacent to the microfluidic channel for heating the analyte solution, wherein the cooling element operates to maintain the channel in a closed state by cooling the analyte solution in the channel and wherein the heating element may be activated to place the channel in an open state by heating the analyte solution in the channel; and a detector for detecting the dispensed analyte solution

The invention also provides a microfluidic device and/or valve, including a substrate having a micro fluidic channel for carrying an analyte solution; a cooling element associated with the substrate and micro fluidic channel for cooling the analyte solution in the channel; and a heating element adjacent to the channel for heating the analyte solution in the channel wherein the cooling element operates to maintain the channel in a closed state by cooling the analyte solution in the channel and wherein the heating element may be activated to place the channel in an open state by heating the cooled analyte solution in the channel.

The invention also provides a method of valve control in a microfluidic device, including maintaining a cooling element in an active state to freeze an analyte solution in a microfluidic channel and close the microfluidic channel; and engaging a heating element to thaw the analyte solution in the microfluidic channel and open the microfluidic channel to allow fluid flow through the channel.

### BACKGROUND

Various microfluidic systems and devices have been designed for moving small samples and solutions. These systems have been quite efficient and effective in analyzing, characterizing and determining small molecules or volumes. In certain cases assays have also been designed to be executed directly on these microfluidic devices or chips. Various molecules or solutions are mixed using valves that release precise amounts of small molecules or reagents over time.

In microfluidic systems where valving is required, mechanical structures have been employed. Mechanical structures have been the standard mode of design for a variety of systems. However, there are a number of issues when dealing with small mechanical or moving parts are involved. For instance, moving parts can often break down or cause problems because of their small size. In addition, deformable micromechanical structures are often difficult to fabricate. Lastly, the physical properties present at these small sizes can be quite difficult to deal with. For instance, with microfluidics systems, often times pressure causes enormous stress on the parts or system. These physical issues are real and need to be dealt with in an effective manner. To date none of the mechanical structures are particularly effective in being able to act as a valve to release reagents or to activate their release at will, at high pressure. In addition, it would be desirable to develop a system or device in which the parts do not wear out over time or which are difficult to manufacture.

These and other limitations of the prior art have been obviated by the present invention.

### SUMMARY OF THE INVENTION

The invention provides a microfluidic system comprising a separation system for preparing and separating an analyte solution, a microfluidic device downstream from the separation system for dispensing an analyte solution, comprising a substrate having a channel defining a portion of a microfluidic channel, a polymeric substrate having a channel for contacting the substrate to define the second portion of the microfluidic channel; a cooling element associated with the substrate and channel for cooling an analyte solution in the microfluidic channel and a heating element adjacent to the microfluidic channel for heating the analyte solution, wherein the cooling element operates to maintain the channel in a closed state by cooling the analyte solution in the channel and wherein the heating element may be activated to place the channel in an open state by heating the analyte solution in the channel; and a detector for detecting the dispensed analyte solution

The invention also provides a microfluidic device, comprising a substrate having a micro fluidic channel for carrying an analyte solution; a cooling element associated with the substrate and micro fluidic channel for cooling the analyte solution in the channel; and a heating element adjacent to the channel for heating the analyte solution in the channel wherein the cooling element operates to maintain the channel in a closed state by cooling the analyte solution in the channel and wherein the heating element may be activated to place the channel in an open state by heating the cooled analyte solution in the channel.

The invention also provides a method of valve control in a microfluidic device, comprising maintaining a cooling element in an active state to cool an analyte solution in a microfluidic channel and close the microfluidic channel; and engaging a heating element to warm the analyte solution in the microfluidic channel and open the microfluidic channel to allow fluid to flow through the channel.

### BRIEF DESCRIPTION OF THE FIGURES

The invention is described in detail below with reference to the following figures:

FIG. 1 shows a general block diagram of the present invention.

FIG. 2 shows a plan view of the present invention.

FIG. 3 shows a cross-sectional view of an embodiment of the present invention.

FIG. 4 shows a schematic diagram of a heat transfer model.

FIG. 5 shows a schematic diagram of the same heat transfer model in heating mode.

### DETAILED DESCRIPTION OF THE INVENTION

Before describing the invention in detail, it must be noted that, as used in this specification and the appended claims, the singular forms “a,” “an,” and “the” include plural referents unless the context clearly dictates otherwise. Thus, for example, reference to “a substrate” may include more than one “substrate”, reference to “a heating element” may include more than one “heating elements”.

In describing and claiming the present invention, the following terminology will be used in accordance with the definitions set out below.

The term “adjacent” means near, next to, or adjoining.

The term “micro fluidic device” refers to any device that is very small. In particular the term means any type of device in the size range of about 10⁻⁶ meters The term should be interpreted broadly to include any number of structures and materials that are on a small scale.

The term “substrate” refers to any materials or components capable of being designed with one or more channels. Substrates may comprise one or more materials that are rigid or non-rigid. It is important that the substrate be capable of holding or designing one or more microfluidic channels.

The term “heating element” refers to any system, component or device know or not known in the art that is capable of providing heat. Heating elements may include and not be limited to IR devices, thermistors, coils, thermocouples, RF devices, magnets, and other standard devices known in the art. Heating may be radiative or by conduction or convection.

The term “cooling element” refers to any system, component, or device known or not known in the art that is capable of removing heat or cooling a channel. A number of cooling elements are known in the art. These devices may be convective, conductive and/or may comprise an interior with one or more fluids. For instance, some of the cooling elements may comprise a solution that may be cooled. The solution then cools the surrounding device.

The term “open state” refers to a condition in which a channel in a microfluidic device or system is in a state or condition that will allow solution to flow. This may or may not be in a completely free flowing state. In certain instances this would include a partially flowing state or allowing some flow. In other embodiments this may mean altering or changing the flow or viscosity properties of a solution thermodynamically.

The term “closed state” refers to a condition in which a channel in a microfluidic device or system is in a state or condition that will not allow analyte solution to flow. In certain instances this may mean a partially closed state or slowing a solution to a substantially slow flowing state. In other embodiments this may mean altering or changing the flow or viscosity properties of a solution thermodynamically.

The term “photodefinable refers to any material or polymer that may be defined or constructed through the use of light.

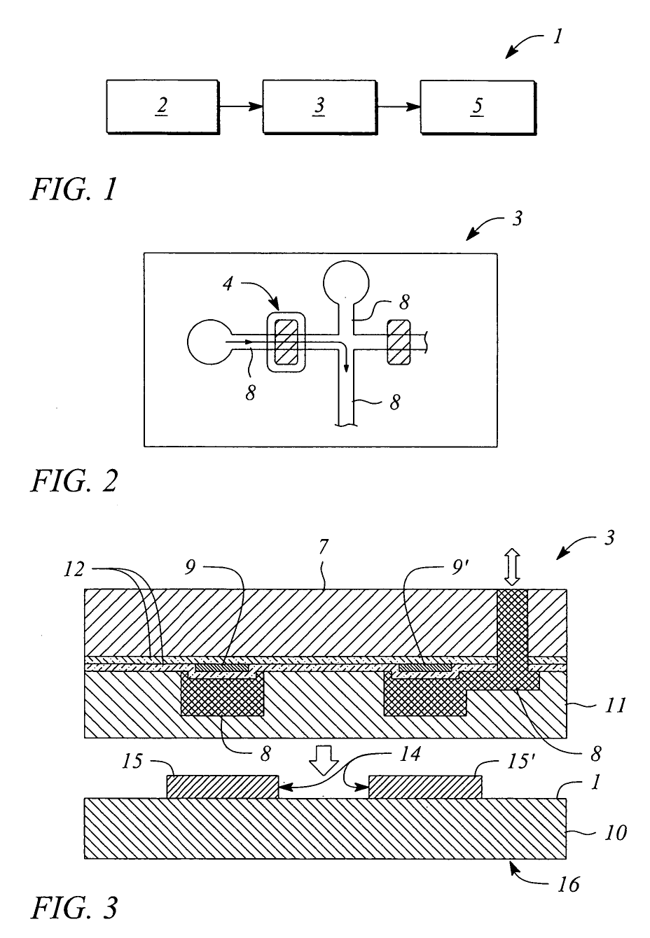

FIG. 1 shows a general block diagram of the analytical system 1 of the present invention. The analytical system 1 comprises an optional separation device 2, a microfluidic device 3, and an optional detector 5. The optional detector 5 is positioned downstream from the microfluidic device 3. The diagram is not to scale and is provided for illustrative purposes only. The microfludic device 3 comprises a microfluidic valve 4. The microfluidic device 3 and microfluidic valve 4 will be discussed in more detail below.

The separation device 2 may comprise any number of devices or systems that may be capable of being coupled to a microfluidic device 3. For instance, any number of separation systems know in the art may be employed. For instance, the separation system may comprise an HPLC device or system, an isoelectric focusing device, a centrifuge or fractionator, an electrophoresis or polyacrylamide gel, etc. Any device or method known in the art for separating and/or isolating molecules for further analysis. In certain instances, the separation device may be integrated or designed directly into or may comprise a portion of the microfluidic device 3.

FIG. 2 shows a plan view of the microfluidic device 3. The figure shows a number of microfluidic channels 8. Various microfluidic channels 8 may be designed to interconnect. Interconnections between channels allows for mixing of various materials or solutions. This may be accomplished by using one or more microfluidic valves or systems that will be discussed in more detail. Ideally one or more systems are important for introducing or mixing various chemicals and solutions. As the figure illustrates, these channels can be quite extensive and complex or they can be very linear and simple. The microfluidic device 3 comprises a substrate 7 having one or more microfluidic channels 8 for carrying an analyte solution, a cooling element 10 associated with the substrate 7 and micro fluidic channel 8 for cooling the analyte solution in the microfluidic channel 8; and one or more heating elements 9 adjacent to the channel 8 for heating the analyte solution in the microfluidic channel 8, wherein the cooling element 10 operates to maintain the microfluidic channel 8 in a closed state by cooling the analyte solution in the microfluidic channel 8 and wherein the heating element 9 may be activated to place the microfluidic channel 8 in an open state by heating the cooled analyte solution in the microfluidic channel 8. The microfluidic valve, comprises a substrate having a channel; and a valve in contact with the substrate comprising a cooling element and heating element wherein the valve operates to open and close the channel and wherein the cooling element operates to maintain the channel in a closed state by cooling the analyte solution in the channel and wherein the heating element may be activated to place the channel in an open state by heating the analyte solution in the channel.

The substrate 7 may comprise a single substrate. In other embodiments it may comprise a number of different substrates that are associated with each other or which are attached or fastened together. For instance, in FIG. 2 the substrate 7 comprises two substrates that may be joined together to form the microfluidic channel 8. This is easy to manufacture since one substrate need only be etched while the other may comprise a polymeric material. When the substrate 7 and the substrate 11 are joined together, the microfluidic channel 8 is then formed. It can also be imagined that a single block substrate may also be employed and the microfluidic channel 8 is produced by boring or designing the microfluidic channel 8 directly into the substrate. The substrate 7 may comprise a number of materials known in the art for designing microfluidic devices. For instance, the substrate 7 may comprise various types of plastics, metals, composite materials and polymers or polymeric materials that may be shaped, formed or molded. These materials may also be designed for etching channels directly in or on their surfaces.

As discussed earlier, microfluidic channel(s) 8 may comprise a variety of shapes, sizes and volumes. These microfluidic channels 8 may also be designed to intersect or connect for mixing various materials and solutions at various stoichiometric ratios. The channels 8 may be designed in different dimensions and shapes. They may be designed in various directions for moving and caring analyte solutions (See FIG. 2). Each of the channels 8 may be similar or different from the other channels in or on the microfluidic channel 8.

As shown in FIG. 2 when the substrate 7 comprises two parts, the second substrate 11 may comprise a polymeric material. A polymeric material is useful and effective for carving and designing channels 8 in the substrate 7 when the substrate 7 and substrate 11 are joined together to form a single substrate.

FIG. 3 shows further details of the heating element 9. The heating element 9 is adjacent to the microfluidic channel 8. It must be located sufficiently close to the microfluidic channel 8 for heating any solutions or materials that have been cooled to a rigid, solid or non flowing state. One or more heating elements 9 and/or 9′ may be employed. It should be noted that the heating element 9 and/or 9′ may comprise a portion of one or more of the substrates, may be disposed in or on one or more of the substrates.

It should be noted that the cooling element 10 stays engaged to maintain the channels 8 in a closed state. In the event that one or more solutions need to be mixed, the heating elements 9 and/or 9′ may be engaged to raise the temperature of the channel 8. This causes the valve to open and allow one or more of the solutions to mix. In certain embodiments, cooling element 9 and/or 9′ may be in the form of a separate cooling block 10. The cooling block 10 may be designed with one or more micro-machined surfaces 15 and/or 15′ that may or may not be raised surfaces that more effectively and efficiently provide for transfer of cold from the second substrate 10, and avoid heat transfer elsewhere.

Having described the apparatus of the invention, a description of the method of operations is now in order. Basically an analyte sample is introduced into the separation device 2. The separation device 2 further separates and/or purifies the sample in preparation for introduction into the microfluidic device 3. The sample is sent from the microfluidic device 3 to the detector 5. The detector 5 may then further separate and/or identify or characterize the molecules.

However, before the analtye sample reach the detector 5 it must pass through the microfluidic device 3. As discussed above the analyte is prepared by a separation device 2. This is not a requirement of the invention. In certain embodiments, the analyte sample may be introduced directly into the microfluidic device 3 without any further purification or separation. Ideally, the analyte will be introduced to the microfluidic device 3 by way of one or more microfluidic channels 8. Certain solutions may be sealed or prevented from entering the main microfluidic channel 8 by use of the present valve design. For instance, the cooling element 10 is engaged to close one or more microfluidic channels 8. This is accomplished by cooling the solutions in the channel to such a level that they no longer will allow flow. The present invention does this in a variety of way and maintains the channels in a closed state. In the event that it is desirable to introduce another solution to the analyte or to allow the analyte to flow for further processing, the heating element 9 or 9′ may then be engaged. The heating element 9 and/or 9′ provides heat at a level that sufficiently heats and melts the analyte in the channel 8 that it allows it to flow. The heating element 9 and/or 9′ and/or cooling element 10 can be engaged at various times for mixing and introducing various amounts in stoichiometric ratios into the channels 8. The cooling element 10 may be disposed in the substrate 11 or may be a separate block that is used to contact the substrate 7 and/or polymeric substrate 11 (See FIG. 3). In the form of a substrate 10 the cold block may use one or more micro-machined surfaces 15 and/or 15′ that may contact the substrate 7 and/or polymeric substrate 11 and cool it.

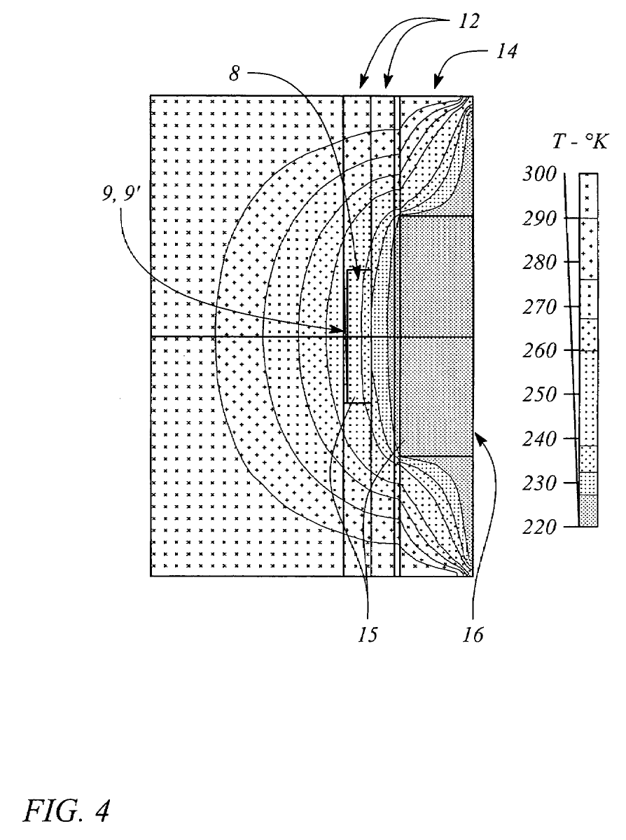

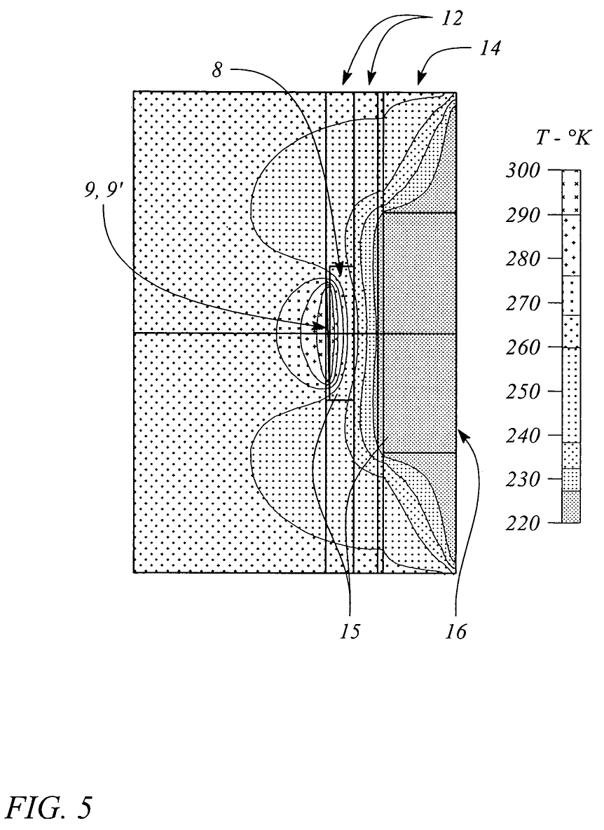

FIGS. 4 and 5 show various examples of the present invention in operation. FIG. 4 shows the model in a closed state (i.e. contact with a cold block or engaging a cooling element). The model shows a region of the microfluidic device contacting a cold body at approximately 220K. There is a gap on either side of the top surface of cold body where contact does not occur. With the thermal parameters chosen, the analyte solution is below 273K. In the case of analyte or with water, freezing would occur. This model is axis symmetric around the X-axis. The ambient temperature is 300K. FIG. 5 shows the same model as in FIG. 4, except that the heater is now engaging a heat flux of 2.5E6 W/m². At this flux, the analyte would either be partly or fully melted, allowing flow to occur.

We claim:

1. A microfluidic device, comprising:
(a) a substrate having a microfluidic channel for carrying an analyte solution;
(b) a cooling element associated with the substrate and channel for cooling the analyte solution in the microfluidic channel; and
(c) a heating element adjacent to the channel for heating the analyte solution in the channel;
wherein the cooling element operates to maintain the channel in a closed state by cooling the analyte solution in the channel and wherein the heating element may be activated to place the channel in an open state by heating the cooled analyte solution in the channel.

2. A microfluidic device as recited in claim 1, wherein a portion of the substrate comprises a metal.

3. A microfluidic device as recited in claim 2, wherein the metal comprises alumina.

4. A microfluidic device as recited, in claim 1, wherein a portion of the substrate comprises a material selected from the group consisting of a glass, a polymer and a silicon material.

5. A microfluidic device as recited in claim 4, wherein the polymer comprises a photodefinable polymer.

6. A microfluidic device as recited in claim 5, wherein the photodefinable polymer comprises polyimide.

7. A microfluidic device as recited in claim 1, wherein the heating element comprises a thermistor.

8. A microfluidic device as recited in claim 1, wherein the heating element comprises a thermocouple.

9. a microfluidic device as recited in claim 1, wherein the heating element is disposed in the substrate.

10. A microfluidic device, comprising:
(a) a substrate having a channel defining a first portion of a microfluidic channel;
(b) a polymeric substrate having a channel for contacting the substrate to define the second portion of the microfluidic channel;
(c) a cooling element associated with the substrate and channel for cooling an analyte solution in the microfluidic channel; and
(d) a heating element adjacent to the microfluidic channel for heating the analyte solution;
wherein the cooling element operates to maintain the channel in a closed state by cooling the analyte solution in the channel and wherein the heating element may be activated to place the channel in an open state by heating the analyte solution in the channel.

11. A microfluidic device as recited in claim 1, wherein a portion of the substrate comprises a metal.

12. A microfluidic device as recited in claim 11, wherein the metal comprises alumina.

13. A microfluidic device as recited, in claim 10, wherein a portion of the substrate comprises a material selected from the group consisting of a glass, a polymer and a silicon material.

14. A microfluidic device as recited in claim 13, wherein the polymer is a photodefinable polymer.

15. A microfluidic device as recited in claim 14, wherein the photodefinable polymer comprises polyimide.

16. A microfluidic device as recited in claim 10, wherein the heating element comprises a thermistor.

17. A microlfuidic device as recited in claim 10, wherein the heating element comprises a thermocouple.

18. a microfluidic device as recited in claim 10, wherein the heating element is disposed in the substrate.

19. A microfluidic system, comprising:
(a) a separation system for separating and preparing an analyte solution;
(b) a microfluidic device downstream from the separation system for dispensing an analyte solution, comprising:
i. a substrate having a channel defining a portion of a microfluidic channel;
ii. a polymeric substrate having a channel for contacting the substrate to define the second portion of the microfluidic channel;
iii. a cooling element associated with the substrate and channel for cooling an analyte solution in the microfluidic channel; and
iv. a heating element adjacent to the microfluidic channel for heating the analyte solution;
wherein the cooling element operates to maintain the channel in a closed state by cooling the analyte solution in the channel and wherein the heating element may be activated to place the channel in an open state by heating the analyte solution in the channel; and
(c) a detector for detecting the dispensed analyte solution

20. A microfluidic device as recited in claim 19, wherein a portion of the substrate comprises a metal.

21. A microfluidic device as recited in claim 20, wherein the metal comprises alumina.

22. A microfluidic device as recited, in claim 19, wherein a portion of the substrate comprises a material selected from the group consisting of a glass, a polymer and a silicon material.

23. A microfluidic device as recited in claim 22, wherein the polymer is a photodefinable polymer.

24. A microfluidic device as recited in claim 23, wherein the photodefinable polymer comprises polyimide.

25. A microfluidic device as recited in claim 19, wherein the heating element comprises a thermistor.

26. A microlfuidic device as recited in claim 19, wherein the heating element comprises a thermocouple.

27. a microfluidic device as recited in claim 19, wherein the heating element is disposed in the substrate.

28. A microfluidic valve, comprising:
(a) a substrate having a channel; and
(b) a valve in contact with the substrate comprising a cooling element and heating element wherein the valve operates to open and close the channel and wherein cooling element operates to maintain the channel in a closed state by cooling the analyte solution in the channel and wherein the heating element may be activated to place the channel in an open state by heating the analyte solution in the channel.

29. A microfluidic valve as recited in claim 28, wherein a portion of the substrate comprises a metal.

30. A microfluidic valve as recited in claim 29, wherein the metal comprises alumina.

31. A microfluidic valve as recited, in claim 28, wherein a portion of the substrate comprises a material selected from the group consisting of a glass, a polymer and a silicon material.

32. A microfluidic valve as recited in claim 28, wherein the polymer is a photodefinable polymer.

33. A microfluidic valve as recited in claim 32, wherein the photodefinable polymer comprises polyimide.

34. A microfluidic valve as recited in claim 28, wherein the heating element comprises a thermistor.

35. A microlfuidic valve as recited in claim 28, wherein the heating element comprises a thermocouple.

36. a microfluidic valve as recited in claim 28, wherein the heating element is disposed in the substrate.

37. A method of valve control in a microfluidic device, comprising:
(a) maintaining a cooling element in an active state to freeze an analyte solution in a microfluidic channel and close the microfluidic channel; and
(b) engaging a heating element to thaw the analyte solution in the microfluidic channel and open the microfluidic channel to allow fluid flow through the channel.
